(19) United States
(12) Patent Application Publication
(10) Pub. No.: US 2005/0136542 A1
(43) Pub. Date: Jun. 23, 2005

(54) Stabilized liquid reference solutions

(75) Inventors: Jeff C. Todtleben, Prior Lake, MN (US); Stephen P. Chan, Minneapolis, MN (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 10/741,403

(22) Filed: Dec. 19, 2003

(51) Int. Cl. G01N 31/00

(52) U.S. Cl. 436/15

(57) ABSTRACT

Stabilizing liquid reference solutions containing basic polypeptide analytes, amino acids with basic side chains and stabilizing protein are provided for use as calibrators and controls for immunoassays.

### FIELD OF THE INVENTION

The present invention is directed towards stabilized liquid reference solutions. More particularly, the present invention is directed towards liquid reference solutions of one or more cardiac markers.

### BACKGROUND

Laboratory tests are routinely performed on the serum or plasma of whole blood in automated instruments. Internal quality control is a process used for monitoring instrument calibration performance, particularly precision or reproducibility. A calibrator is used to ensure the accuracy of a diagnostic assay test and/or an instrument system at multiple response levels. A control is used to test and confirm the accuracy and reliability of a diagnostic assay test and/or an instrument system. Enhanced stability of calibrators and controls to survive thermal stress and refrigerated storage condition improves reliability of the system and/or provides for more convenient transport and storage between their use.

Both calibrators and controls are solutions having an analyte or analytes in a matrix that has characteristics similar to the matrix in which the samples to be analyzed exist. The storage of the calibrators and controls for periods of time is sometimes necessary. Depending on the analyte in question, these demands on the stability of the reference solution can present problems. For example, protein and peptides are subject to enzymatic, oxidation, or reduction modification in the aqueous solution.

Analytes that are basic protein peptides dissolved in aqueous solution are susceptible to physical and chemical alterations during storage. These denaturation processes result in loss of binding activity, which hampers the development of calibrator and control materials with long-term storage in the liquid state.

Common protein stabilization additives include dissolved components, such as sucrose and glycerol that result in an increase in background noise in the assay or an increase in the viscosity of the liquid matrix thus compromising measurement accuracy and assay precision. Other stabilization methods require the protein to be lyophilized and reconstituted at the time of use. Lyophilization can impact the activity of a protein or polypeptide.

Several physiologic basic proteins are useful as cardiac biomarkers for detection of myocardial infarction and heart failure. For example, troponin I and T are useful markers for myocardial infarction and for identifying patients at risk for short and long term adverse cardiac events, such as unstable angina and congestive heart failure. B-type natriuretic peptide (BNP) has also been used as a cardiac marker. The isoelectric points for human cardiac troponin I (cTnI) and human BNP are around pl of 10.

A matrix which increases the stability of the protein in a liquid reference solution while preserving the structure of the protein and that does not interfere with assay performance is desired.

### SUMMARY OF THE INVENTION

The present invention provides a stable liquid reference solution comprising a basic protein or polypeptide, an amino acid with a basic side chain, such as arginine, histidine, and lysine and a stabilizing protein, such as, bovine serum albumin. The reference solution in one aspect also includes a non-ionic surfactant, such as, polyoxyethylene sorbitan monolaurate (TWEEN), a chelating agent, such as, ethylene diamine tetracetic acid (EDTA), ethylenebis (oxyethylene nitrilio)-tetraacetic acid (EGTA), citrates, or oxalates, metal salts or a mixture thereof.

In one aspect the basic protein is a partially purified cTnI fraction from human heart extracts comprising native troponin I-T-C complex such as that commercially available from SCIPAC, Sittingbourne, UK. In another aspect the protein is a natriuretic peptide such as B-type natriuretic peptide or a fragment thereof.

In one aspect of the invention, the reference solution is a “multianalyte” control or calibrator. “Multianalyte” as used herein means one reference solution comprising at least two different proteins or polypeptides that may be used to test a diagnostic test and/or instrument system and will parallel at least two different analytes.

The reference solutions of the invention may be optimized for use with any automated analyzer having a test for the analyte or analytes for which the solution is manufactured. In one aspect the reference solutions are adapted for use with the ACCESS® Immunoassay System, the ACCESS® 2 Immunoassay System, the UniCel™ Dxl 800 Immunoassay System and the Synchron LX®I 725 Clinical System (the “Beckman Systems”), each of which is available from Beckman Coulter, Inc. of Fullerton, Calif.

In another aspect the reference solution is used in a method of assuring quality of an immunoassay test to detect the presence or amount of a basic polypeptide analyte that includes the use of a reference solution comprising the basic polypeptide or fragment or related polypeptide thereof and a stabilizing solution, wherein the stabilizing solution comprises one or more amino acids selected from the group consisting of arginine, lysine and histidine and a stabilizing protein. The stable reference solution is then used as the sample with an assay test kit designed to detect the presence of the basic polypeptide in a patient sample. In one embodiment, a plurality of stable liquid reference solutions are prepared each having a different known reference quantity of the polypeptide or fragment or related polypeptide thereof contained therein.

### DETAILED DESCRIPTION

The instant invention is directed to stable liquid reference solutions for use in assays detecting the presence and/or amount of basic protein analytes, such as the cardiac markers troponin I and BNP in a patient's sample. The reference solution comprises a basic polypeptide and a stabilizing solution, wherein the stabilizing solution comprises one or more amino acids selected from the group consisting of arginine, lysine and histidine and a stabilizing protein. The stabilized liquid reference solution may be a control with a measurable amount of the reference protein or polypeptide or it may be a calibrator formulation containing known amounts of the reference protein or polypeptide. In one aspect the reference solution includes a plurality of different reference proteins or polypeptides with varying and known molecular weights. The reference solutions of the invention are stable for nine weeks at 4° C. “Stable” or “stabilized” as used herein in connection with the reference solutions of the invention means that the proteins or polypeptide components of the reference solution can be stored at refrigerated temperatures for greater than 30 days and are robust to decay from thermal stress potentially occurring in shipping conditions.

The stabilized liquid reference solution is useful in the clinical or diagnostic setting for providing controls or calibrators for cardiac event diagnosis. The reagents necessary to detect and assess cardiac events, including the calibrators and controls may be stored as a liquid and, thus, be readily available so that cardiopulmonary status may be quickly and efficiently assessed. The stable liquid reference solution of the invention will be illustrated herein with respect to two cardiac markers, troponin I and BNP used for cardiac event diagnosis.

The term “marker” as used herein refers to proteins or polypeptides to be used as analytes for screening test samples obtained from subjects. The terms “protein” and “polypeptide” used in connection with the liquid reference solution of the invention are contemplated to include any fragments thereof, in particular, immunologically detectable fragments. Additionally, certain proteins and polypeptides useful as markers are synthesized in an inactive form, which may be subsequently activated, e.g., by proteolysis, and the terms “protein” and “polypeptide” also encompass such markers that may be detected as a surrogate for the marker itself. These polypeptides may be, for example, “pre,” “pro,” or “prepro” forms of markers, or the “pre,” “pro,” or “prepro” fragment removed to form the mature marker.

Cardiac troponin I is a cardiospecific marker that is often used in diagnosis of a cardiac event. It is a contractile protein that exists as a complex of three subunits, I, T, and C, and is expressed exclusively in cardiac muscle. Troponin I can be found free, i.e., uncomplexed, as troponin I (TnI), complexed with Troponin C (binary IC), with troponin T (binary IT), or both troponin I and C (ternary ITC).

In the event of a cardiac event, or coronary disease, damage to the cardiac muscle causes the release of TnI into the blood system of the individual. For diagnostic purposes, the presence of TnI in blood serum or plasma is useful for assessing whether damage to the cardiac muscle has occurred.

During early triage, typically, three blood samples are collected from a patient that presents with chest pain or other symptoms suggestive of coronary events. The blood samples are assayed for the presence and level of TnI. Elevated TnI levels are diagnostically useful because TnI does not normally circulate in the blood system and can be detected as early as three hours after the onset of chest pain and remains elevated for as long as nine days post acute myocardial infarction. Determination of levels of TnI is also useful for evaluating the risk of health complications due to acute angina.

After a cardiac event, the predominate form of TnI in a patient's blood is the binary troponin IC complex with smaller amounts of the ternary ITC complex. Because there is evidence of differential recognition of the different forms, it is useful to employ assay techniques wherein the different forms are equally recognized so that an unbiased determination of the total TnI present in a sample can be determined.

A number of assays for cardiac troponin I (cTnI) are commercially available, including the Dade Behring Dimensions assay, the Abbott AxSYM® assay, and the Access® AccuTnI™ assay. Each assay product has a different format designed for use with that particular instrument system but the stable liquid reference solutions of the invention may be adapted for use with any assay format where the use of a reference solution stored in liquid form is desirable. In one aspect, the reference solutions of the invention are adapted to be run on the Beckman Systems. An ACCESS® immunoassay test kit for cardiac troponin I that is currently commercialized is described in Uettwiller-Geiger, et al., “Multicenter Evaluation of an Automated Assay for Troponin I,” Clin. Chemistry, Vol. 48:6, pages 869-876 (2002), the teachings of which are hereby incorporated by reference. Briefly, the immunoassay uses two murine monoclonal antibodies. One antibody is directed to amino acids 2440 of troponin I and is conjugated to alkaline phosphatase, and the other antibody is directed to amino acids 41-49 of troponin I and is coated on paramagnetic particles. The antibodies recognize the free cardiac troponin I, the binary troponin IC complex as well as the ternary troponin ITC complex. TnI present in the sample binds to the antibody on the paramagnetic particles and the alkaline phosphatase conjugate binds to the bound TnI. The amount or presence of bound is detected using a luminometer by the addition of chemiluminescent substrate which reacts with alkaline phosphatase. The amount of analyte in the sample is quantified from a stored, multi-point calibration curve.

It is desirable to provide a stored reference solution that will remain stable in refrigerated temperatures (from about 2° C. to about 10° C.) over a period of days so that clinical sites can readily perform assays and quickly diagnose and assess coronary health and other disease states. In one aspect, the stable liquid reference solutions of the invention are stable in the liquid form for at least seven days at room temperature or at 37° C. and as long as about 9 weeks at 4° C.

In one aspect of the invention the reference solution may contain an amount of native, recombinant, or synthetic TnI. In a preferred aspect of the invention the reference solution contains native TnI, such as that available from Strategic Biosolutions, Inc or SCIPAC Ltd. A series of calibrators may be provided at increasing amounts of TnI so that a standard curve may be produced and the amount of TnI in a patient's sample mathematically determined. The reference solution may also be a control.

Another protein that is useful as a cardiac marker is B-type natriuretic peptide (BNP). This protein is useful for the diagnosis and assessment of congestive heart failure and to assess the risk stratification of patients with acute coronary syndromes. BNP is a hormone involved in the regulation of blood pressure and is released into the bloodstream as blood pressure increases. The level of BNP in the blood is directly proportional to the severity or stage of congestive heart failure.

Assessment of blood levels of BNP is useful for detecting congestive heart failure in early stages of congestive heart failure. Detecting plasma levels of BNP is a useful, rapid, non-invasive method of diagnosis and assessment of the severity of congestive heart failure in a particular patient.

BNP levels may be detected and quantified by a variety of methods that are well known in the art. One of the first such tests commercially available is the Triage® BNP Test available from Biosite Incorporated, San Diego, Calif. The Triage® BNP Test is a fluorescence immunoassay that measures B-type natriuretic peptide (BNP) in whole blood and plasma specimens. The test contains murine monoclonal and omniclonal antibodies against BNP, labeled with a fluorescent dye and immobilized on a solid phase.

“Label”, “labeled” and “labeled conjugate” and the like refer to a conjugate of antibody, receptor or other binding component with a chemical label such as an enzyme, a fluorescent compound, a radioisotope, a chromophore, or any other detectable chemical specie, the conjugate retaining the capacity to specifically bind to its binding partner. “Detection system,” and the like, as exemplified below, refers to a chemical system that provides detectable signals. Illustrative examples of labels include any of those known in the art, including enzymes, pigments, dyes, fluorophores, radioisotopes, stable free radicals luminescers such as chemiluminescers, biolumiescers, and the like. In a signal detection system useful in the method of the invention, the label is an enzyme the detectable signal of which may be generated by exposing the labeled reagent to a particular substrate and incubating for color, fluorescence or luminescence development.

The stable liquid reference solutions of the invention may be adapted for use with any system for which a BNP assay can be performed. These include for example the Elecsys® proBNP (pro brain natriuretic peptide) assay available from Roche Diagnostics of Indianapolis, Ind., the B-type Natriuretic Peptide (BNP) assay available from Bayer Diagnostics Corporation, Tarrytown, N.Y. developed for use on the ADVIA® Centaur™ Immunoassay System, and the Axis-Shield BNP test for use on the Abbott AxSYM® automated immunoassay system.

In addition to comprising a measurable amount of a polypeptide that has a dilution linearity to the physiologic polypeptide being detected, the stable liquid reference solutions of the invention comprise one or more amino acids having a basic side chain, for example, arginine, lysine, or histidine, dissolved in an aqueous solution and include a stabilizing protein, such as albumin, human serum albumin or bovine serum albumin. The amino acid and stabilizing protein concentrations are adapted for each assay to increase thermal stress stability and to protect against alteration in the protein or polypeptide folding and denaturation. The concentrations are also adapted so that the reference polypeptide in the liquid reference solution is capable of demonstrating dilution parallelism to the polypeptide in a physiological serum or plasma environment and analyte dilution linearity. For example, arginine ranging from 2.5-10% (w/v) concentration was determined experimentally by titering into solution.

Typically, calibrators and controls for immunoassays are prepared by dissolving the analyte to be measured in normal human serum. This is done to ensure that the calibrators match the clinical serum sample as closely as possible. However, basic polypeptide, such as troponin and BNP degrade when incorporated into normal human serum. Artificial matrices of normal human serum is prepared using bovine serum albumin or other protein such as human serum albumin, fetal calf serum, equine serum, bovine gamma globulin or ovalbumin in amounts sufficient to approximate the average protein concentration of human serum along with buffer and salts to approximate the pH and ionic strength of serum. For example, BSA concentration ranging from 1%-7% can be used. Stability can be determined by comparing the reference solutions of the invention with similarly prepared dilutions of calibrators or controls from a commercial source whose effective polypeptide content has been measured by a standard method. The response of the reference material of the invention can be compared to calibrators or controls stored at −20 C or the baseline.

Any form of amino acids having basic side chains may be used. For example, any stereoisomer (L, D, or DL) or analogue of the amino acids from synthetic and natural sources may be used. Amino acid analogues are derivatives of naturally occurring amino acids.

A non-ionic surfactant such as, for example, polysorbate 80 (Tween 80), polysorbate 20 (Tween 20), polyoxypropylene-poltoxyethylene esters, polyoxyethylene alcohols, polyethylene glycol, and polyoxyeththylene sorbitol esters may be added to optimally orient the hydrophilic and hydrophobic regions of the protein or polypeptide so that the epitope sites are readily recognized by antibodies in immunoassay applications. Optimal orientation of the epitope sites increases the binding of the antibodies to the analytes. Non-ionic surfactants also assist in stabilizing the protein or polypeptide during cycles of freezing and thawing and protect the molecule from mechanical shearing forces.

Additionally, chelating agents, such as ethylene diamine tetracetic acid (EDTA), ethylenebis (oxyethylene nitrilio)-tetraacetic acid (EGTA), citrates, or oxalates, may be used in the liquid reference to further stabilize the reference protein or polypeptide. For example, EDTA protects the protein or polypeptide against methionine oxidation. Chelators, such as EDTA, however, may have an adverse effect on the stability of some basic polypeptides, such as troponin I, while increasing the stability of other polypeptides. In other instances, chelators are added to maintain consistency of the patient plasma matrix and is therefore desirable although no effect is seen on protein stability.

In one embodiment of the invention, stable liquid reference solutions are prepared containing BNP polypeptide obtained from BioSite Inc. incorporated into a stabilizing solution that includes a buffer solution with 1% (w/v) bovine serum albumin, 5% (w/v) arginine and 0.15% (v/v) of the non-ionic surfactant, polysorbate 80. In one embodiment the liquid reference solution for BNP assays also includes 4 mM EDTA.

Useful standard curve ranges for BNP reference solutions include concentrations of 0.0 pg/mL to approximately 5000 pg/mL. Useful standard curve ranges for TnI include 0.0 ng/mL to approximately 100.0 ng/mL. The upper end of the range may be increased or decreased as necessary or permitted by the particular application. The range may be distributed over two or more standard levels.

Stable controls of the invention may be provided that include a variety of concentration levels to correspond to the particular application. For example, controls at three levels; low, medium, and high may be provided so that the level in the control corresponds to the approximate level in the samples or standard curve. Useful control levels for BNP reference solutions include high levels that range from approximately 80 pg/mL to approximately 2200 pg/mL, with the low level having about 80 pg/mL of analyte, the medium level having about 400 pg/mL of analyte, and the high level having about 2200 pg/mL of analyte. Useful control levels for troponin I include concentrations that range from approximately 0.05 ng/mL to approximately 50 ng/mL. The lowest level may be of a concentration of about 0.05 ng/mL, medium level about 1.7 ng/mL, and the high level about 50 ng/mL. The amounts in any of the three levels may be increased or decreased, depending on the particular application.

Monovalent and bivalent salts, such as, for example, sodium chloride and calcium chloride may also be included in the aqueous solution to provide an appropriate ionic environment. Ions of the salts pair with oppositely charged polar regions distributed over the protein or peptide molecule.

The electric charge on the protein or polypeptide that is stored and stabilized in the stabilizing liquid reference solution is controlled by the pH environment of the aqueous solution and by selection of appropriate buffers by techniques well known to those skilled in the art. The proper pH of the buffer and/or aqueous solution can be determined by the isoelectric point of the particular protein or polypeptide being stabilized as is known by those skilled in the art.

Another aspect of the invention is directed to an immunoassay kit comprising a first antibody which binds to one epitopic site of a cardiac marker polypeptide analyte selected from the group consisting of troponin and BNP and a second antibody which binds to a different epitopic site of the cardiac marker analyte, wherein at least one of said antibodies is coupled to an enzyme and further comprising a set of stable liquid calibrators. Each calibrator of the kit includes a known quantity of the cardiac marker polypeptide, wherein the polypeptide is selected from the group consisting of a native troponin I, native troponin I-C complex, native troponin I-T-C complex, synthetic and recombinant troponin I-T-C complex, native, synthetic and recombinant B-type natriuretic peptide and each calibrator includes a stabilizing solution, wherein the stabilizing solution comprises one or more amino acids having a basic side chain and a stabilizing protein.

The following example is illustrative of the invention and are not intended to limit the scope of the invention as set out in the appended claims.

### EXAMPLE I

### Troponin I Calibrator and Control Stabilizing Liquid Reference Solution

A plurality of stable liquid reference solutions containing three different concentrations of native troponin I (purified from human heart tissue) in the stabilizing solution was prepared. The troponin polypeptides was incorporated into a stabilizing solution that included a buffer solution with 1% (w/v) bovine serum albumin, 5% arginine (w/v) and a non-ionic surfactant, and polysorbate 80 at 0.15% (v/v). The pH of the solution with troponin I was adjusted to 6.8±0.1. The solution also included preservatives commonly found in reference solutions. Native troponin I antigen from two different vendors were incorporated into each of the liquid reference solutions. The solutions were tested using an ACCESS® Immunoassay System with the ACCESS® AccuTnI™ commercially available test kit at 3, 5, and 11 days following storage of the reference solutions at 45° C. The results are set forth below.

Stability Data

| Target Conc. | Troponin | % Recovery at 45° C. | | |
|---|---|---|---|---|
| (ng/mL) | Antigen | Day 3 | Day 5 | Day 11 |
| 0.3 | HTI ITC | 104.1% | 94.7% | 96.5% |
| 0.3 | Scipac ITC | 102.5% | 95.4% | 95.3% |
| 1.2 | HTI ITC | 102.1% | 98.7% | 95.3% |
| 1.2 | Scipac ITC | 104.1% | 96.7% | 91.8% |
| 5 | HTI ITC | 104.9% | 100.0% | 95.9% |
| 5 | Scipac ITC | 104.1% | 96.3% | 91.6% |

The foregoing description of the invention and the examples ing the application of the invention are but exemplary of the ways the an be utilized. That other variations will be useful will be apparent to ed in the art. Therefore, the present invention is to be considered limited appended claims.

1. A stable liquid reference solution for assays for detecting the presence or amount of a cardiac marker present in a sample comprising a reference polypeptide, wherein the reference polypeptide is selected from the group consisting of a native troponin I, native troponin I-C complex, native troponin I-T-C complex, synthetic and recombinant troponin I-T-C complex, native, synthetic and recombinant B-type natriuretic peptide and the reference solution further includes a stabilizing solution, wherein the stabilizing solution comprises one or more amino acids having a basic side chain and a stabilizing protein.

2. The solution of claim 1 wherein the stabilizing protein is selected from the group consisting of human serum albumin, bovine serum albumin, fetal calf serum, equine serum, bovine gamma globulin or ovalbumin

3. The solution of claim 1 wherein the stabilizing protein is bovine serum albumin.

4. The solution of claim 1 wherein the amino acids in the stabilizing solution are selected from the group consisting of arginine, lysine, and histidine.

5. The solution of claim 1 wherein the amino acid in the stabilizing solution is arginine.

6. The solution of claim 1 wherein the reference polypeptide has a dilution linearity parallel to the physiological isoforms of the cardiac marker present in the sample and wherein the dilution linearity of the reference polypeptide is maintained for at least nine weeks at refrigerated temperature.

7. The solution of claim 1 further comprising a non-ionic surfactant.

8. The solution of claim 7 wherein the non-ionic surfactant is polysorbate 80.

9. The solution of claim 1 wherein the reference polypeptide is a B-type natriuretic peptide.

10. The solution of claim 9 further comprising a chelating agent.

11. The solution of claim 10 wherein the chelating agent is selected from the group consisting of ethylene diamine tetracetic acid (EDTA), ethylenebis (oxyethylene nitrilio)-tetraacetic acid (EGTA), citrates or oxalates.

12. The solution of claim 1 further comprising metal salts.

13. A stable liquid control for assays for detecting the presence or amount of a plurality of different polypeptide analytes present in a sample, wherein at least one polypeptide analyte is selected from group consisting of troponin I and B-type natriuretic peptide, wherein the control comprises a plurality of reference polypeptides, so that one reference polypeptide is included for each polypeptide analyte being detected and wherein the control further comprises a stabilizing solution, wherein the stabilizing solution comprises one or more amino acids selected from the group consisting of arginine, lysine and histidine and a stabilizing protein.

14. The solution of claim 13 wherein the stabilizing protein is selected from the group consisting of human serum albumin, bovine serum albumin, fetal calf serum, equine serum, bovine gamma globulin and ovalbumin

15. The solution of claim 13 wherein the stabilizing protein is bovine serum albumin.

16. The solution of claim 13 wherein each of the reference polypeptides has a dilution linearity parallel to the physiological isoform of the corresponding polypeptide analyte present in a human sample and which dilution linearity is maintained for at least nine weeks at refrigerated temperature.

17. The solution of claim 16 further comprising a non-ionic surfactant.

18. The solution of claim 17 wherein the non-ionic surfactant is polysorbate 80.

19. The solution of claim 16 further comprising metal salts.

20. A stable liquid reference solution for immunoassays for detecting the presence or amount of a B-type natriuretic peptide in a sample comprising a measurable amount of the B-type natriuretic peptide and a stabilizing solution, wherein the stabilizing solution comprises one or more amino acids selected from the group consisting of arginine, lysine and histidine, a stabilizing protein selected from the group consisting of bovine serum albumin and human albumin, a chelating agent and a buffered media

21. The reference solution of claim 20 wherein the amino acid and stabilizing protein are present in amounts sufficient to maintain the dilution linearity of the B-type natriuretic peptide to its physiological isoform present in a human sample for at least nine weeks at refrigerated temperature.

22. A stable liquid control for assays for detecting the presence or amount of a plurality of different cardiac markers present in a sample, wherein at least one cardiac marker is selected from group consisting of troponin I and B-type natriuretic peptide, wherein the control comprises a measurable quantity of a reference polypeptide for each cardiac marker being detected and a stabilizing solution comprising one or more amino acids having a basic side chain and a stabilizing protein.

23. The control of claim 22 wherein the cardiac markers panel includes troponin I, troponin T, BNP, and NT-proBNP.

24. A method for increasing storage stability of a liquid reference solution for assays for detecting the presence or amount of a cardiac marker in a sample, said method comprising incorporating into a buffered media a reference polypeptide for the cardiac marker being detected that is selected from the group consisting of native troponin and BNP; adding one or more amino acids selected from the group consisting of arginine, lysine and histidine to the buffered media, and adding a stabilizing protein

25. The method of claim 24 wherein the amino acids and stabilizing protein are added in amounts sufficient to maintain the dilution linearity of the reference polypeptide to its physiological isoform present in a human sample for at least nine weeks at refrigerated temperature.

26. A method of assuring the quality of an immunoassay test to detect the presence or amount of a cardiac marker comprising using a reference solution that comprises a reference polypeptide selected from the group consisting of native troponin and BNP and a stabilizing solution that comprises one or more amino acids selected from the group consisting of arginine, lysine and histidine and a stabilizing protein as an unknown sample with the immunoassay test.

27. An immunoassay kit comprising a first antibody which binds to one epitopic site of a cardiac marker selected from the group consisting of troponin and BNP and a second antibody which binds to a different epitopic site of the cardiac marker, wherein at least one of said antibodies is labeled and further comprising a set of stable liquid calibrators, each calibrator comprising a known quantity of a reference selected from the group consisting of native troponin I, native troponin I-C complex, native troponin I-T-C complex, synthetic and recombinant troponin I-T-C complex, native, synthetic and recombinant B-type natriuretic peptide and a stabilizing solution, wherein the stabilizing solution comprises one or more amino acids selected from the group consisting of arginine, lysine and histidine and a stabilizing protein.
